(19) United States
(12) Patent Application Publication
(10) Pub. No.: US 2009/0217738 A1
(43) Pub. Date: Sep. 3, 2009

(54) KNOCK DETECTION DEVICE FOR INTERNAL COMBUSTION ENGINE

(75) Inventors: Naoki Kokubo, Nukata-gun (JP); Satoshi Masuda, Kariya-city (JP); Hirohiko Yamada, Okazaki-city (JP); Shuhei Oe, Kariya-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/372,140

(22) Filed: Feb. 17, 2009

(30) Foreign Application Priority Data
Feb. 29, 2008 (JP) 2008-50264

(51) Int. Cl. G01L 23/22

(52) U.S. Cl. 73/35.09

(57) ABSTRACT

A knock sensor signal is converted by an A/D conversion part in a specified knock determination range. In a time-frequency analysis part, data of frequency, time, and vibration intensity are extracted at the same time from an output signal of the knock sensor and the time-varying patterns of vibration intensity of multiple frequency ranges are extracted. Contours of the time-varying patterns of vibration intensity in multiple frequency ranges are extracted. Vectors indicating directions along which the vibration intensities vary are approximated by the contour of the time-varying pattern of vibration intensity in each frequency range according to the least-squares method. A knock determination is executed based on whether directions of any two or more of multiple vectors are within a predetermined range. Alternatively, a knock determination is executed based on whether a ratio of length of any two or more of the vectors is within a predetermined range.

### CROSS-REFERENCE TO RELATED APPLICATION

This application is based on Japanese Patent Application No. 2008-50264 filed on Feb. 29, 2008, the disclosure of which is incorporated herein by reference.

### FIELD OF THE INVENTION

The present invention relates to a knock detection device for an internal combustion engine. The knock detection device detects a knock on the basis of a time-varying pattern of vibration intensity extracted from an output signal of a knock signal output device.

### BACKGROUND OF THE INVENTION

As described in JP-2005-188297A, when a knock is caused, a phenomenon called “a low frequency shift” is caused. In the low frequency shift, a peak frequency of a vibration component specific to the knock gradually shifts to a lower frequency side. When a peak frequency of vibration component of one knock frequency range extracted from the output signal of the knock sensor gradually shifts to a lower frequency side, it is determined that a knock is caused.

An internal combustion engine is provided with various systems such as a variable valve timing controller and a super-charger in order to improve an output, a fuel economy and an environmental performance. A direct injection engine varies fuel injection timing according to a combustion mode. Thus, many kinds of noises tend to superimpose on the signal of the knock sensor in a knock determination range. However, in the knock detection apparatus described in JP-2005-188297A, it is only determined whether a vibration component of one knock frequency range shifts to a lower frequency side in time sequence. Thus, as shown in FIG. 4, when a plurality of noises are superimposed on the signal of the knock sensor in time sequence in one knock determination range, there is a possibility of making an erroneous determination that one continuous vibration component will shift apparently to a lower frequency side. Therefore, when it is only determined whether the vibration component of one frequency range shifts to a lower frequency side, there is a possibility of making an erroneous determination that a knock is caused.

### SUMMARY OF THE INVENTION

The present invention is made in view of the above matters, and it is an object of the present invention to provide a knock detection device for an internal combustion engine, which can avoid an erroneous knock determination due to noises being superimposed on the output signal of a knock signal output device, even if the noises increase. Hence, knock determination accuracy is enhanced.

According to the present invention, a knock detection device includes: a knock signal output means for outputting an output signal of which waveform is varied according to a knock caused while the internal combustion engine is operated; a vibration intensity extraction means for extracting time-varying patterns of vibration intensity in multiple frequency ranges from the output signal of the knock signal output means; and a knock determination means for executing a knock determination based on at least two of a plurality of vectors indicating directions along which vibration intensities in a plurality of frequency ranges temporally vary.

When knock is caused, not only a knock vibration component of a basic frequency of the knock (first-order resonance frequency which is determined by the diameter of the bore of a cylinder and which is about, for example, 7.5 kHz), but also knock vibration components develop at the same time in second-order and higher-order resonance frequency ranges. A phenomenon that plural noises are continuously caused like a low frequency shift is not a phenomenon that develops in plural frequency ranges at the same time but a phenomenon that develops only in a portion of frequency ranges.

According to the present invention, the time-varying patterns of vibration intensity of multiple frequency ranges are extracted from the output signal of the knock signal output means, and a knock determination is executed based on at least two of vectors indicating directions along which vibration intensities in a plurality of frequency ranges temporally vary. Thus, even if a low frequency shift that cannot be distinguished from the knock is developed in any one of frequency range due to a noise being superimposed on the output signal of the knock signal output means, it is possible to prevent making an erroneous determination that the low frequency shift developed by the noise is the knock and hence to increase a knock determination accuracy.

The time-varying patterns of vibration intensity in multiple frequency ranges can be extracted by means of a plurality of band pass filters. Alternatively, a time-frequency analysis of the output signal of the knock signal output means may be performed in order to extract the time-varying patterns of vibration intensity in multiple frequency ranges. The time-frequency analysis includes a short-time Fourier transform (STFT), a wavelet transform, a Wigner distribution. By performing the time-frequency analysis, the data of frequency, time, and vibration intensity can be extracted at the same time from the output signal of the knock signal output means, and the time-varying pattern of vibration intensity of multiple frequency ranges can be produced.

The knock determination may be executed based on whether directions of any two or more of the vectors are within a predetermined range. If the directions of at least two of vectors agree with a direction of the low frequency shift, it can be determined that a knock is caused.

Alternatively, the knock determination means relates lengths of vectors to lengths of the time-varying patterns of vibration intensity in multiple frequency ranges, and the knock determination may be executed based on whether a ratio of lengths of any two of vectors is within a predetermined range.

Alternatively, a knock determination may be executed based on vibration intensities (area) of at least two of the timing-varying patterns of vibration intensities in multiple frequency ranges.

The time-varying patterns of vibration intensity of multiple frequency ranges can be extracted by a time-frequency analysis of the output signal of the knock signal output means.

Alternatively, a knock determination may be executed based on whether a ratio between vibration intensities (area) of any two of the time-varying patterns of vibration intensity in multiple frequency ranges is within a predetermined range.

Generally, the condition in which the knock is easily caused is changed according to an engine speed and/or an engine load. The predetermined range can be varied according to the engine speed and/or the engine load.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view of an engine control system according to a first embodiment of the present invention;

FIG. 2 is a block diagram showing a circuit for processing the output signal of a knock sensor to make a knock determination;

FIG. 3 is a graph schematically showing time-varying patterns of vibration intensity of multiple frequency ranges extracted from output signals of a knock sensor;

FIG. 4 is a graph showing an example in which when the time-varying pattern of vibration intensity is extracted from only one frequency range, an erroneous determination that knock is caused is made due to noises being superimposed on the output signal of the knock sensor;

FIG. 5 is a flow chart showing a processing of a knock determination routine according to a first embodiment; and

FIG. 6 is a flow chart showing a processing of a knock determination routine according to a second embodiment.

### DETAILED DESCRIPTION OF EMBODIMENTS

Embodiments of the present invention will be described hereinafter.

### First Embodiment

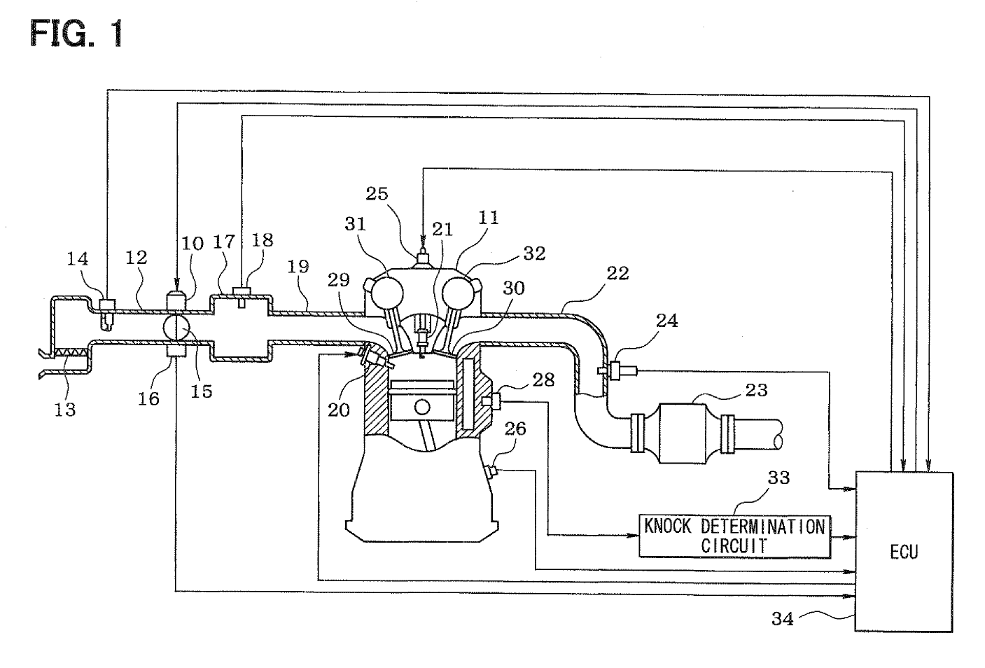

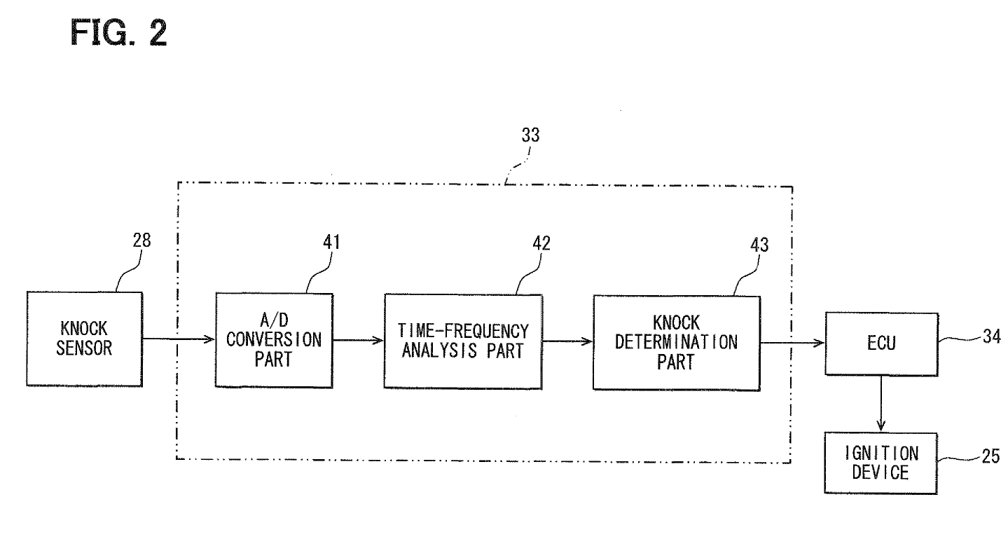

Referring to FIGS. 1 to 5, a first embodiment will be described hereinafter. Referring to FIG. 1, an engine control system is explained. An air cleaner 13 is arranged upstream of an intake pipe 12 of an internal combustion engine 11. An airflow meter 14 detecting an intake air flow rate is provided downstream of the air cleaner 13. A throttle valve 15 driven by a motor 10 and a throttle position sensor 16 detecting a throttle position are provided downstream of the air flow meter 14.

A surge tank 17 including an intake air pressure sensor 18 is provided downstream of the throttle valve 15. The intake air pressure sensor 18 detects intake air pressure An intake manifold 20 is connected to the surge tank 17. A fuel injector 20 is mounted on each cylinder for injecting fuel into an interior of the cylinder respectively. A spark plug 21 is mounted on a cylinder head of the engine 11 corresponding to each cylinder. Each spark plug 21 receives high voltage generated by an ignition device 25 to ignite air-fuel mixture in each cylinder.

The engine 11 is provided with an intake valve timing controller 31 which adjusts a valve timing of the intake valve 29, and an exhaust valve timing controller 32 which adjusts valve timing of an exhaust valve 30.

An exhaust pipe 22 of the engine 11 is provided with a three-way catalyst 23 purifying CO, HC, NOx and the like in the exhaust gas. An exhaust gas sensor 24 detecting air-fuel ratio or rich/lean of the exhaust gas is disposed upstream of the three-way catalyst 25. A crank angle sensor 26 is installed on a cylinder block of the engine 11 to output crank angle pulses when a crank shaft rotates a predetermined angle. Based on these crank angle pulses of the crank angle sensor 26, a crank angle and an engine speed are detected.

The cylinder block of the engine 11 is mounted with a knock sensor 28 for detecting knock vibration, and the output signal of the knock sensor 28 is digitally processed by a knock determination circuit 33 to perform a knock determination. The knock sensor 28 corresponds to a knock signal output means. The knock determination result made by the knock determination circuit 33 is inputted to an electronic control unit 34, which is referred to as ECU 34, hereinafter. The ECU 34 includes a microcomputer which executes an engine control program stored in a Read Only Memory (ROM) to control a fuel injection quantity of the fuel injector 20, an ignition timing of the spark plug 21, and a valve timing of the variable valve timing controllers 31, 32. The ECU 34 repeatedly performs a following knock control so that an ignition timing comes close to a knock limit. That is, when the knock determination circuit 33 detects no knock, the ignition timing is advanced, whereas when the knock determination circuit 33 detects a knock, the ignition timing is retarded.

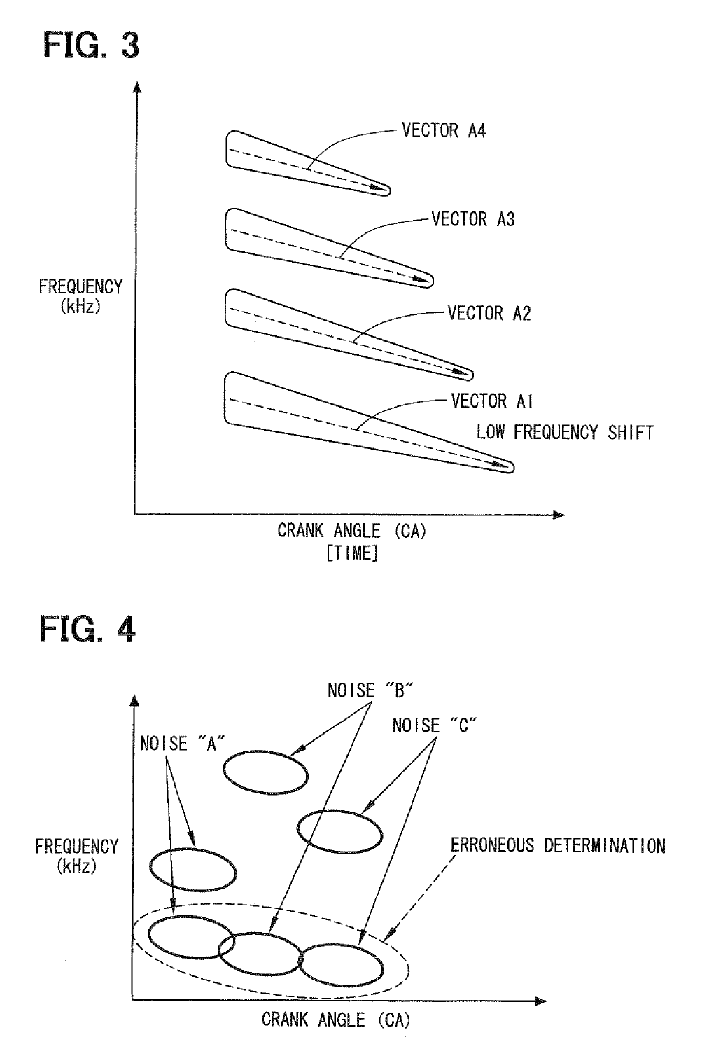

As shown in FIG. 3, when knock is caused, not only a knock vibration component of the basic frequency of the knock (first-order resonance frequency determined by the diameter of the bore of the cylinder) but also knock vibration components of the second-order or more, that is, higher-order resonance frequency ranges develop at the same time. When the knock is caused, the low frequency shift occurs. That is, the vibration components of these multiple frequency ranges gradually shift to a lower frequency side. As shown in FIG. 4, when a plurality of noises are superimposed on the output signal of the knock sensor 28 in time sequence within one knock determination range, there is a possibility of making an erroneous determination that one continuous vibration component will apparently causes a low frequency shift. Thus, when it is only determined whether a vibration component of one frequency range causes a low frequency shift, there is a possibility of making an erroneous knock determination.

The feature of the knock includes the following four features.

(1) A vibration intensity increases rapidly.

(2) Knock attenuates logarithmically (vibration continues).

(3) A vibration intensity develops in multiple frequency ranges.

(4) A low frequency shift develops.

According to the first embodiment, time-varying patterns of vibration intensity in multiple frequency ranges are extracted from an output signal of the knock sensor 28. Then, a knock determination is executed based on whether directions of any two or more of multiple vectors are within a predetermined range. Alternatively, a knock determination is executed based on whether a ratio of length of any two or more of the vectors is within a predetermined range. The vectors indicate variation directions of the vibration intensity in multiple frequency ranges. The ratio of vector length is a ratio of length in a direction of the low frequency shift.

In the present first embodiment, a time-frequency analysis is used to extract the time-varying patterns of vibration intensity in multiple frequency ranges from the output signals of the knock sensor 28. A short-time Fourier transform (STFT), a wavelet transform, a Wigner distribution, or the like is used as the time-frequency analysis.

The processing of the time-frequency analysis is performed by a time-frequency analysis part 42 in the knock determination circuit 33. The time-frequency analysis part 42 corresponds to a vibration intensity extraction means. The output signal of the knock sensor 28 is converted to a digital value by an A/D conversion part 41. The converted signal is processed by the time-frequency analysis part 42. When a knock is caused, as shown in FIG. 3, time-varying patterns are extracted in the multiple frequency ranges. The frequency ranges in which the time-varying pattern of vibration intensity is extracted include a range of a basic frequency, which is the lowest frequency of the frequencies of the knock vibrations, and the ranges of the second or higher-order resonance frequencies of the knock vibrations. The basic frequency is the first-order resonance frequency determined by the diameter of the bore of the cylinder

A plurality of vectors A1-A4 indicating variation directions of vibration intensity in multiple frequency ranges are computed by a knock determination part 43 on the basis of the analysis result of the time-frequency analysis part 42. Then, a knock determination is made based on whether the directions of the vectors A1-A4 or the ratio between the lengths of the vectors A1-A4 are within the predetermined ranges. The vector length corresponds to a length of the time-varying pattern of vibration intensity in a direction of the low frequency direction.

Specifically, an edge extraction technique of image processing is applied to the result of the time-frequency analysis shown in FIG. 3 in order to extract the contours (edges) of the time-varying patterns of vibration intensity of multiple frequency ranges. For example, in FIG. 3, in a case that a time axis (crank angle axis) direction is an x direction, a frequency axis direction is a y direction, and a pixel value at arbitrary coordinates (x, y) is G(x, y), the gradient of density at the coordinates (Δx, Δy) is expressed by the following equations.

Δx(x, y)=G(x−1, y)−G(x, y)

Δy(x, y)=G(x, y−1)−G(x, y)

An edge intensity Vn(x, y) at the arbitrary coordinates (x, y) is expressed by the following equation.

Vn(x, y)=\sqrt{Δx(x, y)²+Δy(x, y)²} [Equation 1]

An edge direction θn(x, y) at the arbitrary coordinates (x, y) is expressed by the following equation.

$$θ n ( x , y ) = {tan}^{- 1} ( \frac{Δ y ( x , y )}{Δ x ( x , y )} ) \qquad [ Equation 2 ]$$

The edge direction θn(x, y) points from a dark side of a change in the density to a light side. A portion where the gradient of density (Δx, Δy) changes by a specified value or more may be determined to be a contour. Alternatively, a portion where a density change quantity in the adjacent regions changes by a specified value or more may be determined to be a contour. Further, a contour (edge) extraction method may be changed according to an engine speed and/or an engine load.

After the processing of extracting the contours (edges) of the time-varying patterns of vibration intensity in the multiple frequency ranges is finished, the knock determination part 43 approximates the vectors A1-A4 by the contour of the time-varying patterns of vibration intensity according to the least-squares method. Thereby, the directions of the vector A1-A4 are mostly in agreement with the directions of the low frequency shift of the vibration intensity in each frequency area.

The knock determination is executed based on whether the directions of any two or more of the vectors A1-A4 within the predetermined range. Alternatively, the knock determination is executed based on whether a ratio of length of any two of the vectors A1-A4 is within the predetermined range. The ratio of vector length is expressed by |A1|/|A3|, |A1|/|A2|, |A1|/|A4|, |A2|/|A4|, or |A2|/|A3|, for example. It should be noted that the predetermined range includes dispersion due to a knock being caused.

The information of the determination result of the knock determination part 43 is sent to the ECU 34. The ECU 34 repeatedly performs a knock control in which the ignition timing is advanced when no knock is detected and the ignition timing is retarded when a knock is detected, whereby the ignition timing comes close to a knock limit.

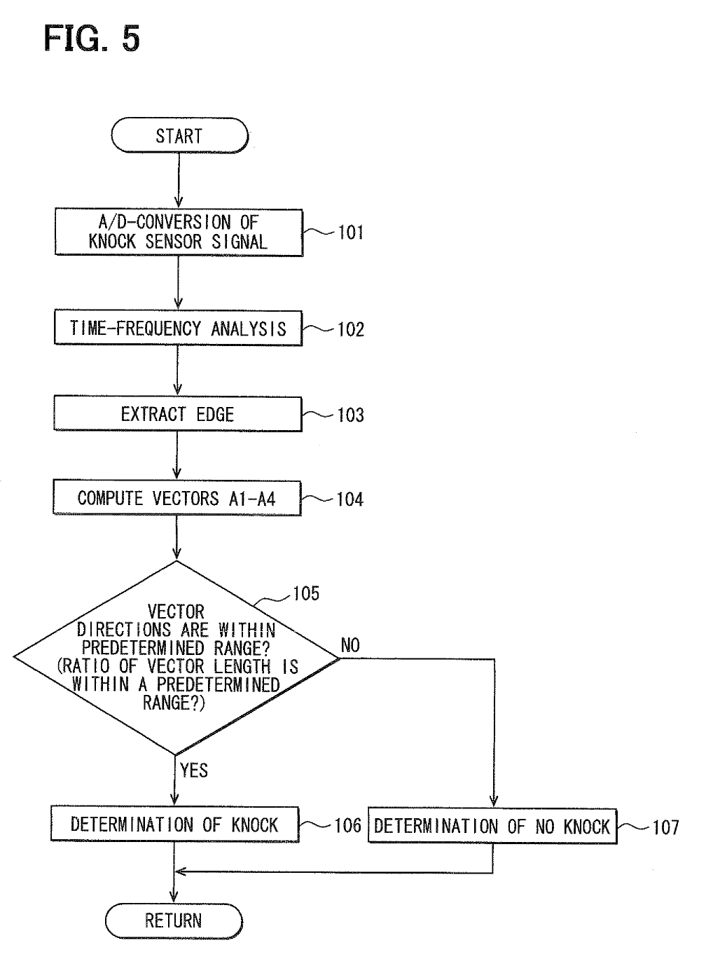

The above-mentioned knock determination processing is performed by the knock determination circuit 33 according to a knock determination routine shown in FIG. 5. The knock determination routine shown in FIG. 5 is performed for each one ignition of each cylinder. In step 101, the output signal of the knock sensor 28 is converted by the A/D conversion part 41 to a digital signal in a specified knock determination range. In step 102, the time-frequency analysis (STFT, wavelet transform, Wigner distribution, or the like) is performed to extract the data of frequency, time, and vibration intensity at the same time from the output signal of the knock sensor 28, thereby extracting the time-varying patterns of vibration intensity in the multiple frequency ranges. Thereafter, the procedure proceeds to step 103 in which a contour extraction processing is performed to compute the edge direction θn(x, y) and the edge intensity Vn(x, y) according to the equation (1) and the equation (2), whereby contours of the time-varying patterns of vibration intensity in the multiple frequency ranges are extracted.

Then, the procedure proceeds to step 104 in which the vectors A1-A4 are approximated by the contour of the time-varying pattern of vibration intensity in each frequency range according to the least-squares method. Then, the procedure proceeds to step 105 in which the knock determination is executed based on whether the directions of two or more of vectors A1-A4 are within the predetermined range. Alternatively, the knock determination is executed based on whether a ratio of length of any two of vectors A1-A4 is within the predetermined range. When the answer is Yes in step 105, the procedure proceeds to step 106 in which the computer determines that a knock is caused. When the answer is No in step 105, the procedure proceeds to step 107 in which the computer determines that no knock is caused. With this manner, even if a low frequency shift that cannot be distinguished from the knock in any one of the frequency ranges is developed due to the noises being superimposed on the output signal of the knock sensor 28, it is possible to prevent making an erroneous determination that the low frequency shift developed by the noises is the knock. Thus, the knock determination accuracy is enhanced.

As for the predetermined range (a determination threshold), a constant value (fixed value) may be used which is previously set in an adjustment process on the basis of the intensity and the frequency that can be allowed from the sense of hearing of the worker. However, the condition in which the knock is easily caused varies according to engine speed, engine load, and the like, so that the predetermined range may be set according to the engine speed and/or the engine load. With this, it is possible to determine whether a knock is caused under the knock determination condition suitable for the engine speed and/or the engine load.

The predetermined range may be corrected according to a knock detection frequency. Under the operating condition in which the knock detection frequency is low, the predetermined range is set narrow to make it difficult to detect the knock. The ignition timing is advanced to improve the output and the fuel economy. Under the operating condition in which the knock detection frequency is high, the predetermined range is set wide to make it easy to detect a knock. The ignition timing is retarded to restrict the knock within an allowance in terms of the sense of hearing.

### Second Embodiment

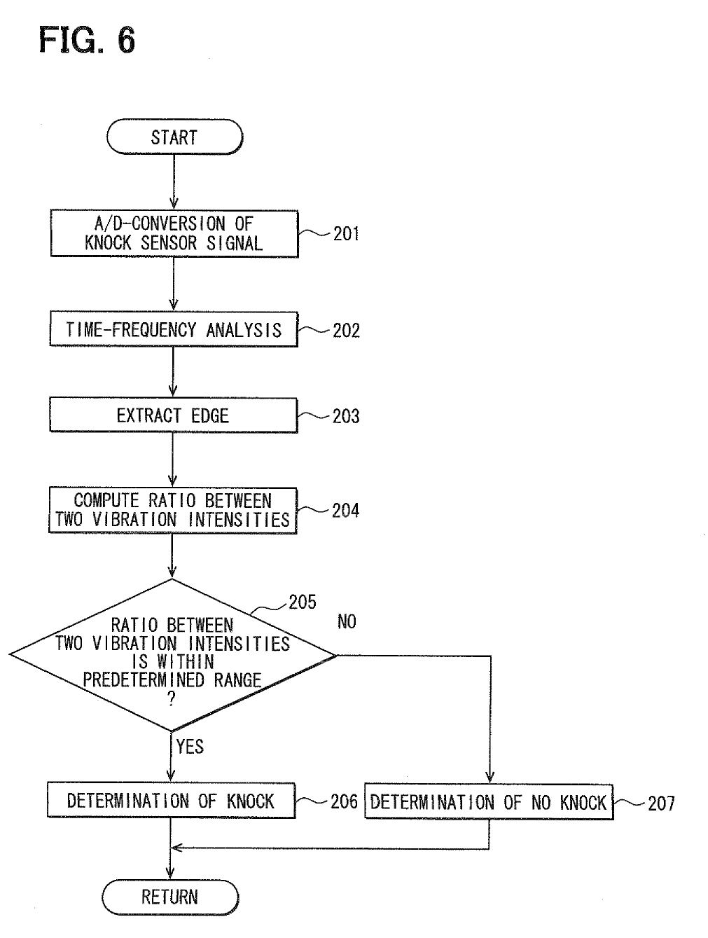

According to the second embodiment shown in FIG. 6, a knock determination is executed based on whether a ratio of vibration intensity (area) between any two of the time-varying patterns is within a predetermined range. The other configurations are the same as those of the first embodiment.

The knock determination routine shown in FIG. 6 is performed for each one ignition of each cylinder. In step 201, the output signal of the knock sensor 28 is converted by the A/D conversion part 41 to a digital signal. In step 202, a time-frequency analysis is executed to extract data of frequency, time, and vibration intensity at the same time from the output signal of the knock sensor 28. Then, the time-varying patterns of vibration intensity in multiple frequency ranges are extracted. The procedure proceeds to step 203 in which contours of the time-varying patterns of vibration intensity in multiple frequency ranges are extracted.

Then, the procedure proceeds to step 204 in which the vibration intensities (areas) of any two of time-varying patterns of vibration intensity in multiple ranges are computed and a ratio between two vibration intensities is computed. The procedure proceeds to step 205 in which the computer determines whether the ratio between two vibration intensities is within the predetermined range. When the answer is Yes in step 205, the procedure proceeds to step 206 in which the computer determines that a knock is caused. When the answer is No, the procedure proceeds to step 207 in which the computer determines that no knock is caused. With this manner, even if a low frequency shift that cannot be distinguished from the knock in any one of the frequency ranges is developed due the noises being superimposed on the output signal of the knock sensor 28, it is possible to prevent making an erroneous determination that the low frequency shift developed by the noises is the knock. Thus, the knock determination accuracy is enhanced.

As for the predetermined range (a determination threshold), a constant value (fixed value) may be used which is previously set in an adjustment process on the basis of the intensity and the frequency that can be allowed from the sense of hearing of the worker. However, the condition in which the knock is easily caused varies according to engine speed, engine load, and the like, so that the predetermined range may be set according to the engine speed and/or the engine load. With this, it is possible to determine whether a knock is caused under the knock determination condition suitable for the engine speed and/or the engine load.

The predetermined range may be corrected according to a knock detection frequency. Under the operating condition in which the knock detection frequency is low, the predetermined range is set narrow to make it difficult to detect the knock. The ignition timing is advanced to improve the output and the fuel economy. Under the operating condition in which the knock detection frequency is high, the predetermined range is set wide to make it easy to detect a knock. The ignition timing is retarded to restrict the knock within an allowance in terms of the sense of hearing.

In the above embodiments, the time-frequency analysis is used to extract the time-varying pattern of vibration intensity of the multiple frequency ranges from the output signal of the knock sensor 28. Alternatively, the time-varying pattern of vibration intensity in the multiple frequency ranges may be extracted by means of multiple band pass filters corresponding to the multiple frequency ranges.

In the above embodiments, the knock sensor 28 is used as the knock signal output means of which output signal waveform is varied according to the knock caused during the engine operation. Alternatively, a cylinder pressure sensor for detecting a cylinder pressure or an ion current detection means for detecting ions produced by the combustion of the air-fuel mixture in the cylinder through the ignition plug 21 or the like may be used as the knock signal output means.

The present invention is not limited to a direct injection engine shown in FIG. 1 but can be applied also to an intake port injection engine and a dual injection engine having fuel injectors mounted in both of the intake port and the cylinder. Further, the present invention can be applied to an engine not mounted with a variable valve unit such as a variable valve timing controller. The present invention can be variously modified and put into practice within a range not departing from the spirit and scope of the present invention.

What is claimed is:

1. A knock detection device for an internal combustion engine, comprising:
a knock signal output means for outputting an output signal of which waveform is varied according to a knock caused while the internal combustion engine is operated;
a vibration intensity extraction means for extracting time-varying patterns of vibration intensity in multiple frequency ranges from the output signal of the knock signal output means; and
a knock determination means for executing a knock determination based on at least two of a plurality of vectors indicating directions along which vibration intensities in the multiple frequency ranges temporally vary.

2. A knock detection device according to claim 1, wherein
the vibration intensity extraction means performs a time-frequency analysis of the output signal in order to extract the time-varying pattern of vibration intensity in multiple frequency ranges.

3. A knock detection device according to claim 1, wherein
the knock determination means executes the knock determination based on whether directions of any two or more of the vectors are within a predetermined range.

4. A knock detection device according to claim 1, wherein
the knock determination means relates lengths of vectors to lengths of the time-varying patterns of vibration intensity in multiple frequency ranges, and
the knock determination means executes the knock determination based on whether a ratio of lengths of any two of vectors is within a predetermined range.

5. A knock detection device for an internal combustion engine, comprising:
a knock signal output means for outputting an output signal of which waveform is varied according to a knock caused while the internal combustion engine is operated;
a vibration intensity extraction means for extracting time-varying patterns of vibration intensity in multiple frequency ranges from the output signal of the knock signal output means; and
a knock determination means for executing a knock determination based on vibration intensities of at least two of the timing-varying patterns of vibration intensities in multiple frequency ranges.

6. A knock detection device according to claim 5, wherein
the vibration intensity extraction means performs a time-frequency analysis of the output signal in order to extract the time-varying patterns of vibration intensity in multiple frequency ranges.

7. A knock detection device according to claim 5, wherein
the knock determination means executes the knock determination based on whether a ratio between vibration intensities of any two of the time-varying patterns of vibration intensity in multiple frequency ranges is within a predetermined range.

8. A knock detection device according to claim 3, wherein
the knock determination means varies the predetermined ranges according to an internal combustion engine speed and/or an internal combustion engine load.
